(19) United States
(12) Patent Application Publication
(10) Pub. No.: US 2003/0218065 A1
(43) Pub. Date: Nov. 27, 2003

(54) Apparatus and method for consolidating and using information from a plurality of credit cards

(76) Inventor: Thayamkulangara R. Viswanathan, Addison, TX (US)

Correspondence Address: RAMA NATH, INTERDIGITAL COMMUNICATIONS CORPORATION, 781 THIRD AVENUE, KING OF PRUSSIA, PA, 19406-1409, US

(21) Appl. No.: 10/155,154

(22) Filed: May 25, 2002

(51) Int. Cl. G06K 7/08

(52) U.S. Cl. 235/449

(57) ABSTRACT

A charge card apparatus and method of using the same obviates the need for the user to carry a plurality of regular charge cards on the user's person. In lieu of the plurality of charge cards, which each have magnetic strip, the user carries a charge card apparatus which has two components, i.e. a portable read/write unit and a universal blank charge card. The user records on the read/write unit, for each regular charge card, identification information along with an identification code by swiping the magnetic strip of each regular charge card in a swiping slot of the portable read/write unit. The user carries the recorded read/write unit and can log on into the read/write unit when necessary, by using a pass word/pass code. The user identifies and selects a particular charge card which he wishes to use for a purchase transaction, and swiped the universal blank charge card in the swiping slot to copy and recreate the identification information of the selected regular card, whereby the universal blank charge card can be used in the place of the regular charge card. At the next use of the universal blank charge card, the identification information previously recorded is erased and replaced with new identification information from a regular charge card which is selected by the user and is already recorded on the read/write unit. A personal digital assistant (PDA) may be adapted to function as a charge card apparatus by providing the PDA with a swiping means, e.g., a swiping slot, to swipe the user's charge cards for pre-recording, and to swipe the universal blank charge card to recreate the identification information from the selected regular charge card.

### FIELD OF THE INVENTION

The present invention relates to apparatus and method for consolidating information from a plurality of credit cards and reproducing information relating to a selected credit card from the consolidated information to enable completion of a transaction with a selected credit card without presenting the original of the selected credit card. The terms “credit card” and “charge card” are used synonymously in this invention. Also, for purposes of this invention, debit cards which can be used for depleting existing user's funds, also are considered charge cards.

### BACKGROUND OF THE INVENTION AND A BRIEF DESCRIPTION OF THE PRIOR ART

Credit cards constitute a significant form of conducting business enabling commercial transactions, and have been used for decades all over the world. Generally, credit cards are provided with a magnetic strip/stripe which contains recorded data having sufficient information so as to enable the completion of a transaction. It is known that transactions can be completed by swiping a credit card in a merchant's card reader so that information from the magnetic stripe of the credit card can be processed.

Credit cards are presently more popular than ever, and it is not uncommon for some people to need to carry in a wallet more than half a dozen credit cards such as American Express®, Visa® or Master Card® as well as other cards issued by Banks (Chase®), Credit Unions (Texans), Clubs (Sam's®) and Department Stores (Sears®). Apart from the inconvenience of carrying all these cards in a purse or wallet in one's pocket, there is the possibility of losing all the charge cards at once if the purse or wallet is lost or stolen. Besides, if the user wishes to carry several charge cards in a wallet, the wallet becomes inconveniently bulky in addition to being unsightly and cumbersome in a person's bulging hip-pocket especially while sitting down.

The present invention obviates the need for a person to carry all of a plurality of charge cards on the person, and still enables the person to properly perform transactions with the use of relevant information from any desired charge card owned by the person but not carried on the person. Certain cards such as a driver's license without a magnetic stripe are outside of the ambit of the present invention.

An example of a plastic card with a magnetic stripe can be found in U.S. Pat. No. 5,720,500 to Okazaki et al, wherein the magnetic stripe includes a hologram-magnetic stripe which is intended to deter unauthorized duplication.

U.S. Pat. No. 6,141,161 to Sato et al, teaches apparatus for magnetic recording/reproducing. The Sato apparatus teaches identifying one of a plurality of preset existing current values needed for magnetic card recording depending on a corresponding coercive force identifier.

U.S. Pat. No. 6,039,259 teaches a magnetic card read/write apparatus wherein reading takes place by the movement of the card in a carrier in one direction, and also during the simultaneous continued movement of the card and a head in opposite directions.

Known methods of using charge cards necessitate the user having to carry all the charge cards as necessary. The present invention enables a user to avoid carrying a plurality of charge cards and yet perform transactions using information from any selected card owned by the person.

### SUMMARY OF THE INVENTION

The present invention while obviating the need for a user to carry a multiplicity of charge cards, provides apparatus and method whereby a user is able to recreate information pertaining to a selected charge card for conducting a transaction.

In one form of the present invention, the user, in lieu of the plurality of charge cards which each have a magnetic strip/stipe, carries a charge card apparatus which has two components, i.e., a portable read/write unit and a universal blank charge card. The user records on the portable read/write unit, for each charge card, identification information along with an identification code by swiping the magnetic strip of each regular charge card in a swiping slot of the portable read/write unit. The user carries the recorded portable read/write unit and can log on to the portable read/write unit when necessary, by using a pass word/pass code. The user identifies and selects a particular charge card that he wishes to copy and use for a desired purchase transaction. The user then swipes the universal blank charge card in the swiping slot of the portable read/write unit to copy the identification information of the selected regular charge card, whereby the universal blank charge card can be used in lieu of the regular charge card. At the next use of the universal blank charge card, the identification information previously recorded thereon becomes erased and replaced with new identification information from a regular charge card that is selected by the user and is earlier recorded on the portable read/write unit.

The invention in its broad form resides in a charge card apparatus for storing in a selectively retrievable manner, information from a plurality of charge cards issued to a user, each of the plurality of charge cards including a strip containing readable information pertaining to each relevant card, the apparatus comprising: a portable read/write unit to be carried by the user and having a memory and a viewing window/screen, the portable read/write unit being adapted in a pre-recording mode to read and store information from said strip of each of the user's plurality of charge cards when each of said plurality of charge cards is swiped in the portable read/write unit; the read/write unit may incorporate a swiping slot. A control connected to the portable read/write unit actuates the viewing window/screen to select and access stored information pertaining to a desired charge card selected by the user. A universal blank card including an erasable/writable/readable strip is provided and adapted to recreate information on said universal blank card from a desired charge card selected by the user with the aid of the portable read/write unit.

The invention also resides in a method of consolidating information from a user's plurality of charge cards so as to obviate any need to simultaneously carry all of said plurality of charge cards on the user's person, the plurality of charge cards each including a strip containing readable information pertaining to an associated charge card, the method comprising the steps of: using a portable read/write unit adapted to be carried by the user and having a memory and a viewing window/screen; in a pre-recording mode, reading and storing information from said strip of each of the user's plurality of charge cards by swiping each of the said charge cards on said portable read/write unit; using a control provided on said read/write unit to actuate the viewing window/screen to select and access information pertaining to a desired charge card selected by the user; and using a universal card having an erasable writable/readable strip and recreating selected charge card information on the universal card when desired by the user by applying the universal card to the portable read/write unit in a predetermined manner, the recreated selected charge card information that is recreated on said universal card being sufficient for the user to complete a transaction for the desired charge card selected by the user.

An embodiment of the invention implements the features and method steps of the apparatus stated above, in a personal digital assistant (PDA), e.g., a palm pilot®. However, the embodiment of the personal digital assistant is expediently slotted and incorporates a swiping slot commensurate with the swiping slot provided in the read/write unit of the inventive apparatus. The PDA as commonly known has at least a viewing window, a memory, a keypad and a provision for an access passkey or password. A universal card according to the apparatus of the invention is used in conjunction with the slotted PDA in order to provide the services of a charge card apparatus.

Preferably, in the inventive apparatus, method and the inventive PDA referred to supra, the strip provided on the universal card comprises a magnetic strip much the same as the magnetic strip generally provided on regular charge cards. Modifications of the apparatus, method and the PDA referred to above for providing additional features are conceivable and are within the ambit of the present invention. For example, the viewing window may be an LCD type with or without illumination, or, the viewing window may be an LED type.

### BRIEF DESCRIPTION OF THE DRAWING

A more detailed understanding of the invention may be had from the following description of preferred embodiments, given by way of example and to be understood in conjunction with the accompanying drawings wherein:

FIG. 1 illustrates a front view and a side view of the portable read/write unit of a preferred embodiment of the invention;

FIG. 2 illustrates a schematic view of a universal blank card used with the portable read/write unit of FIG. 1; and,

FIG. 3 shows a perspective illustration of a personal digital assistant adapted with a swiping slot to perform in a manner similar to the portable read/write unit of FIG. 1.

### DETAILED DESCRIPTION OF THE PREFERRED EMBODIMENT

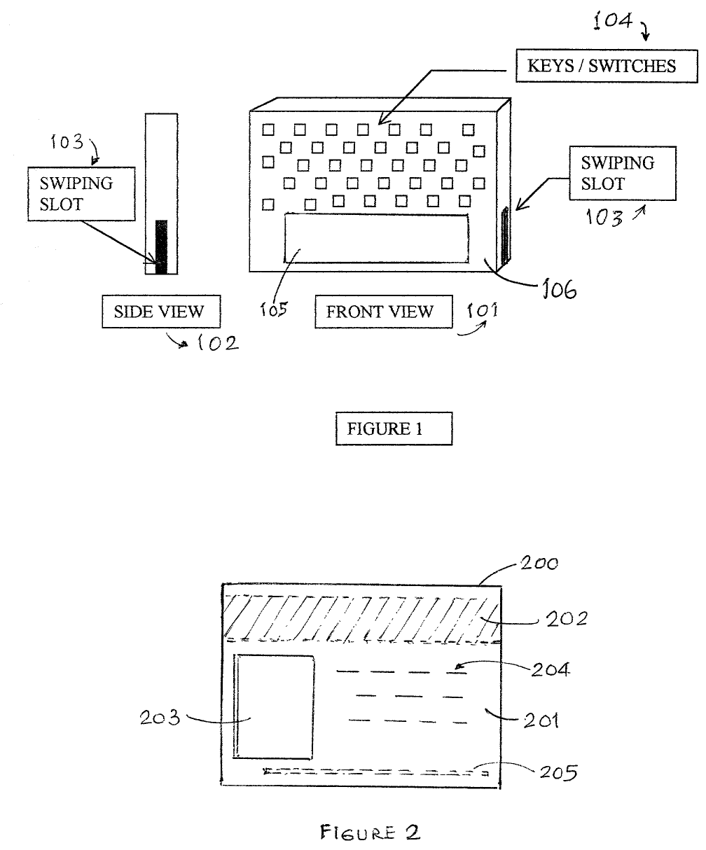

FIG. 1 shows a schematic representation of a portable read/write unit in a preferred embodiment of a charge card apparatus for storing selectively retrievable card identification information from a plurality of charge cards all issued to a user. A front view of the charge card apparatus is illustrated at 101, and shows the body portion of the apparatus at 106. The body portion 106 is preferably the size of a charge card sized calculator and is preferably made of plastic material akin to a conventional charge card. The body portion 106 expediently includes a swiping slot 103 extending preferably over the length of the body portion 106 and including a magnetic interface (not shown) for reading and writing charge card identification information. The identification information preferably includes, the name of the user, the charge card number, the name of the charge service provider, e.g., Visa® or Master Card® or American Express®, as well as expiry date of the relevant charge card. The magnetic interface is connected to a power source (not shown) located preferably within the body portion 106 and is internally connected to a read/write memory embedded in the body portion 106. The identification information preferably includes a code, e.g., a number or an alphabet or a combination of a number and alphabet to identify the identification information of a specific charge card which the user is able to put into the memory during read/write operations of the memory. The body portion 106 preferably includes keys/switches 104 which could be activated by the user for putting in the code or other information into the memory. The key/switches may be of the mechanical type which visibly can be pushed in a manner similar to the keys of a key pad. Alternatively, they may be of the pressure sensitive type. Such keys per se are well known in the art. Additionally the body portion might include an optional window 105 e.g. LCD type, to display a directory listing of the different charge cards with identification and corresponding codes stored in the memory.

FIG. 2 shows a schematic representation of a preferred embodiment of a blank card 200 which includes a rewritable magnetic strip 202. The magnetic strip 202 is capable of retaining any identification and other identification information recorded thereon until erased. Identification information can be recorded on the magnetic strip 202 by (1) activating the keys/switches 104 of the body portion 106 to select identification information chosen by the user and (ii) swiping the blank card 200 in the swiping slot 103 to record the selected identification on the magnetic strip 202.

Optionally, the blank card 200 could be provided with a photographic identification 203 of the user. Preferably the blank card is provided with an address, location and a contact telephone number 205 of the manufacturer of the charge card apparatus including the blank card.

Manner of Using the Charge Card Apparatus:

The present inventive apparatus obviates the need for the user to carry a plurality of charge cards on person thereby avoiding (i) an inconvenience of the wallet becoming unduly thick and (ii) any chance of losing all the charge cards when the wallet is lost or stolen. To this end the user needs to carry (i) a charge card apparatus body portion 106 having prerecorded information from several charge cards of the user and (ii) a blank card 200.

If the user wishes to present his American Express® card to make a purchase, the user accesses and actuates the keys/switches 104 on the apparatus body portion 106 either to put in his known code for the American Express® card or to make his selection from a listing displayed on the window 105. Having made the selection, the user swipes the universal card in the swiping slot 103 in the record transfer mode, Thereby, the required information from the user's selected American Express® card is transferred into the magnetic strip of the universal card. Thereafter, the universal card can be used by the user in place of the regular American Express® card.

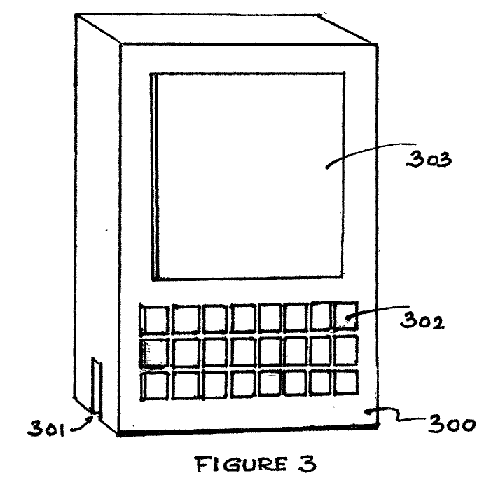

FIG. 3 illustrates a very practical and desirable modification of the invention wherein the charge card apparatus is built into a personal digital assistant, commonly known as the PDA. One well known example of the commercially available PDA, as aforesaid, is the Palm Pilot®. Other similar units with known PDA features are commercially available and are known by different trade names. As shown, FIG. 3 illustrates a PDA 300 which is adapted as a read/write unit. The PDA 300 is adapted and modified as a charge card apparatus by providing the body portion of the PDA with a swiping slot 301 which houses an erase/read/write head (not shown).

The modified PDA includes conventional input keys 302 as part of a keyboard. The input keys may be the pressure sensitive type or any other type. A display screen 303 which normally serves to perform the PDA functions, is used as a display for the viewing window of the read/write unit.

As with the embodiment illustrated in FIGS. 1 and 2, the user initially obtains access into the PDA memory by using an access code. The access code prevents unauthorized use of the charge card apparatus and also misappropriation of any information contained therein. The user then transfers relevant information from the magnetic strips of the user's plurality of charge cards into the PDA unit in a selected prerecording mode by swiping each charge card, one at a time in the slot 301. The user attributes an identifying code to the information transferred from each charge card, and preferably arranges the recorded charge card information from a plurality of cards in a desired sequence. The identifying code and the sequence serve to facilitate the user accessing quickly and without error, relevant charge card information from any card that the user chooses for a commercial transaction. Having identified the required charge card information to be duplicated, the user, in a transfer recording mode swipes the universal card in the slot 301, thereby transferring the selected charge card information into the magnetic strip of the universal card. In the transfer recording mode, any prior recorded information on the universal card is expediently erased and replaced by the new information which the user puts on the universal card. The user will be able to complete a business transaction using the universal card which has the relevant charge card information transferred onto the universal card, as desired by the user. Commercial card readers typically used by merchants will be able to read and accept the universal card with the relevant charge card information recorded thereon by the user.

Additionally, the optional photo identification 203 provided in the universal/blank card assists in preventing fraudulent/unauthorized use of the inventive charge card apparatus and the associated universal card.

The charge card apparatus described above expediently includes a nonvolatile memory to store the charge card information put in by the user in the prerecording mode. The charge card apparatus preferably includes a power supply, e.g., a battery, to support the memory. The battery may be a rechargeable type or a disposable type. Alternatively, the battery may be a photovoltaic type or solar type which can be actuated by light. Disposable batteries may also be used, in which case it is preferable to have a nonvolatile memory so that the user would not be faced with the inconvenience of having to re-enter all the charge card information and the associated codes each time the disposable battery needs to be replaced. It is to be noted that in the embodiment of FIG. 3, the PDA has inherently its power source, which may be a rechargeable or disposable battery. In addition, the PDA has its conventional display window, its keyboard, and a memory. However, a conventionally known PDA does not include any swiping slot as illustrated in FIG. 3, nor any other provision to read/write charge card information. The present invention enables a conventional PDA to be adapted to function as the read/write unit illustrated in FIG. 1. A PDA adapted as a charge card apparatus as illustrated in FIG. 3, inherently will have its viewing window, a memory, a battery and a keyboard, and can be used in association with the universal card illustrated shown in FIG. 2, to enable a user to avoid carrying a plurality of charge cards and still be able to use virtually any of the user's charge cards for transactions.

In summary, the features of the various embodiments of the inventive charge card apparatus include the following:

1. The apparatus can read a set of magnetic-strip cards and store the information under separate codes or labels as desired by the user.

2. The apparatus can retrieve and write selected card information on a universal or blank card thus recreating relevant information about any charge card selected by the user from an original set of cards.

3. The apparatus is portable and can be carried by the user easily. If the apparatus is in the form of a modified PDA, the user carries the modified PDA and only a single universal or blank card which is similar in size to a regular charge card.

4. The apparatus may be made of plastics akin the material of regular charge cards and is not fragile.

5. In order to prevent fraudulent use, the blank card may be provided with the user's identification in an indelible manner. The read/write unit may also be provided with the user's identification, such as the user's photograph. The apparatus includes a log on access code, to prevent unauthorized use.

6. The blank cards which receive the card information installed thereon by the user with the use of the inventive apparatus can be read by commercial card readers all over the world, thus ensuring versatility.

7. The apparatus can be registered in the name of the owner and therefore can be easily replaced if damaged or lost, with minimum consequences.

8. If the blank card alone is lost or stolen, the picture or other identification provided thereon can deter its unauthorized use by others.

Equivalents:

The foregoing text teaches preferred embodiments of the inventive charge card apparatus, with the associated universal card/blank card. Various improvements and modifications may be made to the inventive charge card apparatus without departing from the scope of the invention. For example, the swiping slot in the PDA may be provided at a location different from the one illustrated in FIGS. 1 and 3. Alternatively, the swiping slot may be replaced by a surface which has the erasing/reading/writing heads embedded, wherein the regular charge cards and the universal card are surface swiped rather than swiping in a slot. The power source for the read/write unit may be rechargeable or photogenerative, similar to a solar battery. The universal card may be provided with one or more holograms to render unauthorized reproduction difficult. All such and other modifications are envisaged to be within the scope of the present invention.

1. A charge card apparatus for storing selectively retrievable identification information from a plurality of charge cards issued to a user, each of said plurality of charge cards including a strip containing readable information pertaining to each relevant card, said apparatus comprising a portable read/write unit adapted to be carried by the user and having a memory and a viewing window/screen, said read/write unit being adapted to read and store information from said strip of each of said plurality of charge cards when each of said plurality of charge cards is swiped on said read/write unit; a control on said read/write unit to actuate said viewing window/screen to select and access stored information pertaining to a desired charge card selected by the user; and a universal card including an erasable/writable/readable strip, said read/write unit being adapted to recreate information from said desired charge card on said universal card.

2. Apparatus as in claim 1 wherein said read/write unit includes an erasing head which erases any pre-existing information recorded on said erasable/writable strip of said universal card, and wherein said memory is nonvolatile and is connected to a power supply.

3. Apparatus as in claim 1 wherein said universal card carries user's identification in an indelible form.

4. Apparatus as in claim 3 wherein said user's identification comprises user's name and street address.

5. Apparatus as in claim 3 wherein said user's identification comprises user's facial photograph.

6. Apparatus as in claim 3 wherein said user's identification comprises user's name, street address and photograph.

7. Apparatus as in claim 1 wherein said viewing window comprises of an LCD.

8. Apparatus as in claim 1 wherein said viewing window screen comprises of LED.

9. Apparatus as in claim 1 wherein said portable read/write unit includes a swiping slot

10. Apparatus as in claim 1 wherein said strip containing readable information comprises a magnetic strip.

11. Apparatus as in claim 2 wherein said power supply is built into said read/write unit.

12. Apparatus as in claim 11, wherein said power supply is disposable.

13. A method of consolidating information from a user's plurality of charge cards so as to obviate any need to simultaneously carry all of said plurality of charge cards on the user's person, said plurality of charge cards each including a strip containing readable information pertaining to an associated charge card, said method comprising the steps of: using a portable read/write unit adapted to be carried by the user and having a memory and a viewing window/screen, pre-reading and storing information from said strip of each of the said plurality of charge cards by swiping each of the said charge cards-on said portable read/write unit; using a control provided on said read/write unit to actuate said viewing screen window to select and access information pertaining to a desired charge card selected by the user; and using a universal card having an erasable writable/readable strip for recreating selected charge card information by the user by applying said universal card to said portable read/write unit in a predetermined manner, said recreated selected charge card information on said universal card being sufficient for the user to complete a transaction for said desired charge card.

14. A method as in claim 13, wherein the steps of swiping and applying are performed in a swiping slot provided in said read/write unit.

15. A method in claim 13 wherein said step of recreating selected charge card information includes prior erasing of any information contained on said erasable writable/readable strip of said universal card.

16. A method as in claim 13 wherein said step of pre-reading and storing information comprises swiping said user's plurality of charge cards, one at a time on said portable read/write unit.

17. A method as in claim 13 including the step of providing visible user identification on said universal card.

18. A method as in claim 13 including the step of providing user's identification on said universal card in the form of user's name and street address.

19. A method as in claim 13 including the step of providing user's identification on said universal card in the form of user's photograph

20. A method as in claim 13 including the step of providing user's identification on said universal card in the form of user's name, street address and a facial photograph

21. A method as in claim 13 wherein thee step of pre-reading and storing information comprises reading a magnetic strip in each of said user's plurality of charge cards, and storing read information in a magnetic storage in said portable read/write unit.

22. A method as in claim 13 including the step of the user selecting a desired charge card information from said magnetic storage prior to said step of recreating selected charge card information.

23. A method as in claim 22 wherein the step of user selecting desired charge card information comprises the user actuating a viewable listing of said plurality of charge cards from which information is stored.

24. A method as in claim 13 including the step of erasing pre-existing information on said universal card, wherein the step of erasing is done by an erasing head which is embedded in said portable read/write unit.

25. Apparatus as in claim 2 wherein said erasing head is embedded in said portable read/write unit, said erasing head being wired to erase any prior recorded information on said universal card before recreating information from said desired charge card on said universal card.

26. A portable personal digital assistant (DA) apparatus adapted for use as a charge card apparatus for storing selectively retrievable identification information from a plurality of charge cards issued to a user, each of said plurality of charge cards including a strip containing readable information pertaining to each relevant card, said PDA apparatus comprising a portable read/write unit adapted to be carried by the user and having a memory and a viewing window/screen, said read/write unit being adapted to read and store information from said strip of each of said plurality of charge cards when each of said plurality of charge cards is swiped on said read/write unit; a control on said read/write unit to actuate said viewing window/screen to select and access stored information pertaining to a desired charge card selected by the user; and a universal card including an erasable/writable/readable strip, said read/write unit being adapted to recreate information from said desired charge card on said universal card.

27. A PDA apparatus as in claim 26 including a swiping slot, for selectively swiping each of said plurality of charge cards and said universal card.

28. A method of using a portable personal digital assistant (PDA) apparatus for consolidating and using information from a user's plurality of charge cards so as to obviate any need for the user to simultaneously carry all of said plurality of charge cards on the user's person, said plurality of charge cards each including a strip containing readable information pertaining to an associated charge card, said method comprising the steps of: adapting said PDA to form a portable read/write unit having a memory and a viewing window/screen, pre-reading and storing information from said strip of each of the said plurality of charge cards by swiping each of the said charge cards on said portable read/write unit; using a control provided on said read/write unit to actuate said viewing screen window to select and access information pertaining to a desired charge card selected by the user; and using a universal card having an erasable writable/readable strip for recreating selected charge card information by the user by applying said universal card to said portable read/write unit in a predetermined manner, said recreated selected charge card information on said universal card being sufficient for the user to complete a transaction for said desired charge card.
